(19) United States
(12) Patent Application Publication
(10) Pub. No.: US 2026/0221633 A1
(43) Pub. Date: Jul. 30, 2026

(54) BATTERY CELL AND BATTERY MODULE INCLUDING THE SAME

(71) Applicant: SK ON CO., LTD., Seoul (KR)

(72) Inventor: Byeong Jun PAK, Daejeon (KR)

(21) Appl. No.: 19/454,407

(22) Filed: Jan. 21, 2026

(30) Foreign Application Priority Data
Jan. 24, 2025 (KR) 10-2025-0011322
Aug. 4, 2025 (KR) 10-2025-0107064

(51) Int. Cl. H01M 50/586; H01M 50/152; H01M 50/179; H01M 50/533; H01M 50/213

(52) U.S. Cl. CPC H01M 50/586; H01M 50/152; H01M 50/179; H01M 50/533; H01M 50/213

(57) ABSTRACT

The present disclosure provides a battery cell including a cell case including a sidewall forming an accommodation space therein, and an upper plate in which a through-hole is formed; an electrode assembly disposed in the accommodation space of the cell case; an insulating plate disposed between the electrode assembly and the upper plate and including a hollow portion; and a first current collector electrically connected to a first electrode tab of the electrode assembly, wherein the insulating plate includes a first portion contacting the upper plate; a second portion contacting the electrode assembly or the first current collector; and a third portion formed between the first portion and the second portion, and wherein one of the first portion or the second portion is disposed adjacent to an edge of the hollow portion, and the other thereof is disposed adjacent to an edge of the insulating plate.

### CROSS-REFERENCE TO RELATED APPLICATIONS

This patent document claims the priority and benefits of Korean Patent Application No. 10-2025-0011322 filed on January 24, 2025, and Korean Patent Application No. 10-2025-0107064 filed on August 4, 2025, the disclosures of which are incorporated herein by reference in its entirety.

### TECHNICAL FIELD

The embodiments of the disclosure generally relate to a battery cell and a battery module including the same.

### BACKGROUND

Unlike primary batteries, secondary battery cells may be convenient in that they may be charged and discharged, and thus have attracted a large amount of attention as power sources for various mobile devices, electric vehicles, energy storage devices, or the like.

The secondary battery cell may be manufactured as a pouch-type cell or a can-type cell. The pouch-type cell has a structure in which an electrode assembly is accommodated in a flexible cell case (pouch). The can-type cell has a structure in which an electrode assembly is accommodated in a rigid cell case (can), and may be comprised of a cylindrical cell, a prismatic cell, a coin-type cell, or the like.

### SUMMARY

Due to an empty space between a cell case and an electrode assembly, uniformity may be degraded when the cell case and the electrode assembly are assembled.

When an external impact is applied to a battery cell, stability of the battery cell may be degraded due to absence of a configuration capable of buffering the impact.

According to an aspect of the present disclosure, an insulating plate providing uniform assemblability when manufacturing a battery cell may be provided.

According to an aspect of the present disclosure, an insulating plate for improving stability of a battery cell by buffering an external impact may be provided.

A battery cell and a battery module including the same, of the present disclosure, may be widely applied to devices within green technology fields such as electric vehicles, battery charging stations, photovoltaic power generation using other batteries, wind power generation, or the like. In addition, a battery cell and a battery module including the same, of the present disclosure, may be used in eco-friendly electric vehicles, hybrid vehicles, or the like to ameliorate the effects of climate change by suppressing air pollution and greenhouse gas emissions.

A battery cell according to the present disclosure includes a cell case including a sidewall forming an accommodation space therein, and an upper plate in which a through-hole is formed; an electrode assembly disposed in the accommodation space of the cell case; an insulating plate disposed between the electrode assembly and the upper plate and including a hollow portion; a first current collector electrically connected to a first electrode tab of the electrode assembly; and an electrode terminal electrically connected to the first current collector through the through-hole, wherein the insulating plate includes a first portion contacting the upper plate; a second portion contacting the electrode assembly or the first current collector; and a third portion formed between the first portion and the second portion, and wherein one of the first portion or the second portion is disposed to be adjacent to an edge of the hollow portion, and the other thereof is disposed to be adjacent to an edge of the insulating plate.

According to an embodiment, a bump protruding outwardly from an outer peripheral surface of the insulating plate may be further included.

According to an embodiment, the bump may be disposed to contact an inner surface of the sidewall.

According to an embodiment, the third portion may include at least one curved portion.

According to an embodiment, the at least one curved portion may include a plurality of curved portions.

According to an embodiment, a height of the curved portion may be less than or equal to a height of the insulating plate.

According to an embodiment, the first portion may be disposed to be adjacent to the edge of the hollow portion, and the second portion may be disposed to be adjacent to the edge of the insulating plate.

According to an embodiment, the first portion may be disposed to be adjacent to the edge of the insulating plate, and the second portion may be disposed to be adjacent to the edge of the hollow portion.

According to an embodiment, the first current collector may further include a protrusion protruding toward the electrode terminal, and the electrode terminal may further include an insertion groove into which the protrusion is inserted.

According to an embodiment, a cap plate covering a lower side of the accommodation space of the cell case may be further included, wherein the cap plate may be coupled to the cell case.

According to an embodiment, the upper plate and the sidewall may be integrally formed.

A battery module according to the present disclosure includes a plurality of battery cells; and a module housing accommodating the plurality of battery cells, wherein at least one of the plurality of battery cells includes a cell case including a sidewall forming an accommodation space therein, and an upper plate in which a through-hole is formed; an electrode assembly disposed in the accommodation space of the cell case; an insulating plate disposed between the electrode assembly and the upper plate and including a hollow portion; a first current collector electrically connected to a first electrode tab of the electrode assembly; and an electrode terminal electrically connected to the first current collector through the through-hole, wherein the insulating plate includes a first portion contacting the upper plate; a second portion contacting the electrode assembly or the first current collector; and a third portion formed between the first portion and the second portion, and wherein one of the first portion or the second portion is disposed to be adjacent to an edge of the hollow portion, and the other thereof is disposed to be adjacent to an edge of the insulating plate.

According to an embodiment, the third portion may include at least one curved portion.

### BRIEF DESCRIPTION OF DRAWINGS

Certain aspects, features, and advantages of the present disclosure may be illustrated by the following detailed description with reference to the accompanying drawings.

FIG. 1 is a perspective view of a battery cell according to an embodiment.

FIG. 2 is an exploded perspective view of a battery cell according to an embodiment.

FIGS. 3A and 3B are perspective views of insulating plates according to various embodiments.

FIGS. 4A and 4B are cross-sectional views of the insulating plates of FIGS. 3A and 3B.

FIGS. 5A and 5B are perspective views of insulating plates according to various embodiments.

FIGS. 6A and 6B are cross-sectional views of the insulating plates of FIGS. 5A and 5B.

FIG. 7 is a cross-sectional view of a battery cell according to an embodiment.

FIG. 8 is a cross-sectional view of a battery cell according to another embodiment.

FIG. 9 is a perspective view of a battery module according to an embodiment.

### DETAILED DESCRIPTION

The same reference numerals or reference numerals described in each drawing attached to the present specification denote components or components that perform substantially the same function. For convenience of description and understanding, the same reference numerals or reference numerals may be used in different embodiments. That is, even though components having the same reference number may be illustrated in a plurality of drawings, not all of the plurality of drawings mean an embodiment.

In the following description, singular expressions include plural expressions unless the context clearly indicates otherwise. Terms such as “include” or “construct” may be intended to specify that features, numbers, steps, operations, components, components, or combinations thereof described in the specification exist, and should be understood not to preclude the existence or addition of one or more other features, numbers, steps, operations, components, or combinations thereof.

In addition, in the following description, expressions such as an upper side, an upper portion, on, a lower side, a lower portion, below, a side surface, a front surface, a rear surface, or the like may be expressed based on the direction illustrated in the drawing, and it may be revealed in advance that if the direction of the object may be changed, it may be expressed differently.

In addition, terms including ordinal numbers such as “first” and “second” may be used to distinguish between components in this specification and claim. These ordinal numbers may be used to distinguish identical or similar components from each other, and the meaning of the terms should not be limited to interpretation due to the use of such ordinal numbers. For example, a component combined with such ordinal numbers should not be interpreted in a limited order of use or arrangement by the numbers. If necessary, each ordinal number may be used interchangeably.

Hereinafter, the present disclosure will be described in detail with reference to the accompanying drawings. However, this may be illustrative only and the present disclosure may not be limited to the specific embodiments illustrated exemplarily.

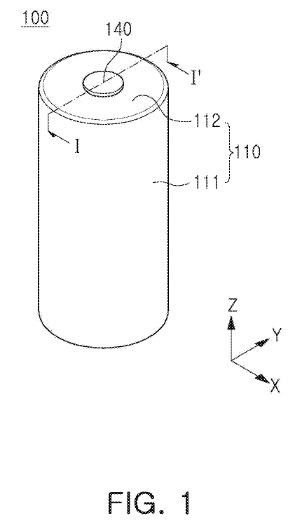

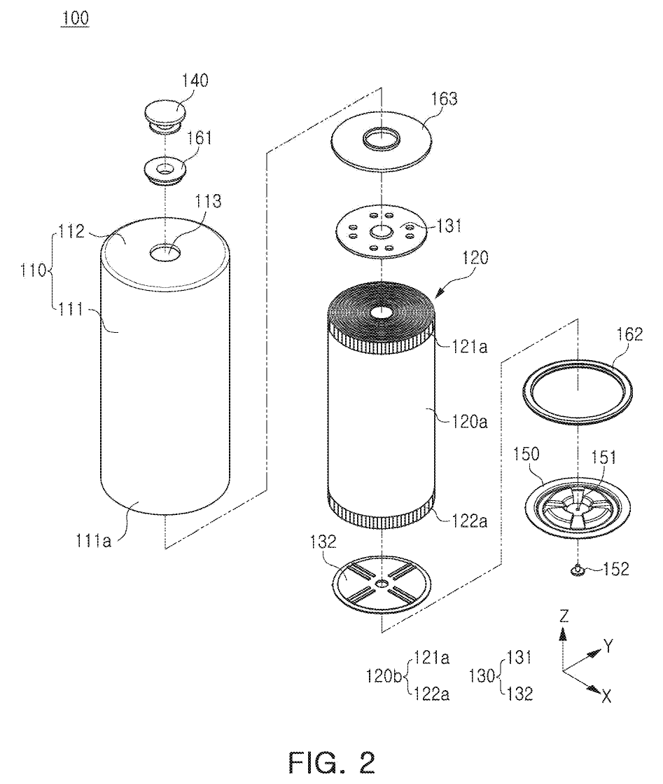

FIG. 1 is a perspective view of a battery cell 100 according to an embodiment. FIG. 2 is an exploded perspective view of a battery cell 100 according to an embodiment.

Referring to FIGS. 1 and 2, a battery cell 100 according to the present disclosure may include a cell case 110 including a sidewall 111 forming an accommodation space 114 therein, and an upper plate 112 in which a through- hole 113 is formed, an electrode assembly 120 disposed in the accommodation space of the cell case 110, an insulating plate 163 disposed between the electrode assembly 120 and the upper plate 112 and including a hollow portion H, a first current collector 131 electrically connected to a first electrode tab of the electrode assembly 120, and an electrode terminal 140 electrically connected to the first current collector 131 through the through-hole 113.

The cell case 110 may include the sidewall 111 forming the accommodation space 114 therein, and the upper plate 112 in which the through-hole 113 is formed. The accommodation space 114 may be formed by the sidewall 111 and the upper plate 112 of the cell case 110. The cell case 110 may have a cylindrical shape of which one side is open. The cell case 110 may have a hollow cylindrical shape having a circular cross-section.

The sidewall 111 may have a tube shape, and the upper plate 112 may have a plate shape covering an upper side of the accommodation space 114.

The sidewall 111 may have a circular tube shape. The upper plate 112 may have a flat plate shape as a whole. Thicknesses of the upper plate 112 and the sidewall 111 in the cell case 110 may be variously changed. For example, the upper plate 112 and the sidewall 111 may have the same thickness, and the thickness of the upper plate 112 may be greater than the thickness of the sidewall 111. The cell case 110 may include a metal material such as aluminum, an aluminum alloy, or the like, but a material of the cell case 110 may be variously changed.

The sidewall 111 and the upper plate 112 of the cell case 110 may be integrally formed. For example, the cell case 110 may be manufactured in a shape in which the sidewall 111 and the upper plate 112 are integrally formed by deep drawing a metal sheet. When the cell case 110 is integrally formed, a process of bonding the sidewall 111 and the upper plate 112 may not be required, and thus the cell case 110 and/or the battery cell 100 may be easily manufactured and workability may be improved.

A cell case 110 of the present disclosure is not limited to a configuration in which the sidewall 111 and the upper plate 112 are integrally formed, and the sidewall 111 and the upper plate 112 may be separately manufactured and then coupled or bonded to each other by welding or the like.

The through-hole 113 may be formed in the upper plate 112 of the cell case 110. The through-hole 113 may be provided in combination with the electrode terminal 140. The cell case 110 may have a circular cross-sectional shape, and the through-hole 113 may be formed in a central portion of the upper plate 112. In this case, the electrode terminal 140 coupled to the through-hole 113 may be disposed in the central portion of the upper plate 112.

The electrode terminal 140 may be coupled to the through-hole 113. At least a portion of the electrode terminal 140 may be exposed to an outside of the cell case 110. Also, at least a portion of the electrode terminal 140 may be disposed in the accommodation space 114 of the cell case 110, and may be electrically connected to the first current collector 131. For example, the electrode terminal 140 may pass through the through-hole 113 to be electrically connected to the first current collector 131. Therefore, when the first current collector 131 is connected to the positive electrode, the electrode terminal 140 may correspond to a positive electrode terminal, and vice versa.

The electrode terminal 140 may be riveted to the through-hole 113 of the cell case 110. The electrode terminal 140 may be riveted to the upper plate 112 by rivet processing while being inserted into the through-hole 113 of the upper plate 112. The electrode terminal 140 may be riveted to the upper plate 112 of the cell case 110. The electrode terminal 140 may have a rivet shape as a whole.

A gasket 161 may be disposed between the electrode terminal 140 and the upper plate 112 for insulation between the electrode terminal 140 and the upper plate 112. The gasket 161 may include an electrically insulating material. The gasket 161 may serve as a sealing member for sealing a space between the electrode terminal 140 and the upper plate 112.

When rivet processing is performed while the gasket 161 is disposed outside the electrode terminal 140, the gasket 161 may be disposed between the electrode terminal 140 and the upper plate 112. The gasket 161 may seal and/or insulate between the electrode terminal 140 and the upper plate 112.

The electrode assembly 120 may be disposed in the accommodation space 114 of the cell case 110. The electrode assembly 120 may include a positive electrode, a negative electrode, and a separator 123. Each of the positive electrode and the negative electrode may include a current collecting foil (or a metal foil) and a mixture layer applied to at least one surface of the current collecting foil. The mixture layer may include an active material. The separator 123 may be interposed between the positive electrode and the negative electrode to electrically insulate the positive electrode from the negative electrode. The positive electrode, the negative electrode, and the separator 123 may be repeatedly disposed to form the electrode assembly 120. As an example, the electrode assembly 120 may have a winding shape in a state in which the positive electrode, the separator 123, and the negative electrode are stacked. The electrode assembly 120 is not limited to a winding structure. For example, the electrode assembly 120 may have a stack shape, a zigzag-folding shape, or a stack-folding shape.

The electrode assembly 120 may include a first electrode 121 and a second electrode 122, having different polarities. As an example, the first electrode 121 may be provided as the positive electrode, and the second electrode 122 may be provided as the negative electrode, and vice versa.

The electrode assembly 120 may include a body 120a in which the first electrode 121 and the second electrode 122 are arranged with the separator 123 interposed therebetween, and an electrode tab 120b extending from the first electrode 121 or the second electrode 122. The body 120a may include a coating portion on which an active material is applied, and the electrode tab 120b may include a non-coating portion on which an active material is not applied. The electrode tab 120b may have a shape of being overlapped or laid down in a predetermined form.

The electrode tab 120b may include a first electrode tab 121a extending from the first electrode 121, and a second electrode tab 122a extending from the second electrode 122. The first electrode tab 121a may include a non-coated portion of the first electrode 121, and the second electrode tab 122a may include a non-coated portion of the second electrode 122.

The electrode tab 120b may be electrically connected to the current collector 130. The current collector 130 may include a first current collector 131 and a second current collector 132. The first electrode tab 121a may be electrically connected to the first current collector 131. For example, the first electrode tab 121a and the first current collector 131 may be electrically connected to each other by welding or the like. The second electrode tab 122a may be electrically connected to at least one of the second current collector 132, a cap plate 150, or the sidewall 111 of the cell case 110. For example, the second electrode tab 122a and the second current collector 132 may be in contact with each other and electrically connected to each other, and may be coupled to each other by welding such as ultrasonic welding, laser welding, or the like. A coupling method of the second electrode tab 122a and the second current collector 132 is not limited thereto.

At least a portion of the first current collector 131 may be electrically connected to the first electrode tab 121a of the electrode assembly 120. Also, at least a portion of the first current collector 131 may be electrically connected to the electrode terminal 140. As an example, the first current collector 131 and the first electrode tab 121a may be coupled to each other by welding such as ultrasonic welding, laser welding, resistance welding, or the like, but the coupling method is not limited thereto. The first current collector 131 and the electrode terminal 140 may be coupled to each other by laser welding or the like.

According to an embodiment, the insulating plate 163 for electrically insulating may be disposed between the first current collector 131 and the cell case 110 for electrical insulation between the first current collector 131 and the cell case 110. For example, the insulating plate 163 may be disposed between the first current collector 131 and the upper plate 112. Alternatively, the insulating plate 163 may be disposed between the electrode assembly 120 and the upper plate 112.

The insulating plate 163 may include the hollow portion H provided in hole form. The hollow portion H may be formed in a central portion of the insulating plate 163. The hollow portion H may provide a path through which the electrode terminal 140 and the first current collector 131 are connected. For example, the electrode terminal 140 may be electrically connected to the first current collector 131 by penetrating the hollow portion H and contacting the first current collector 131.

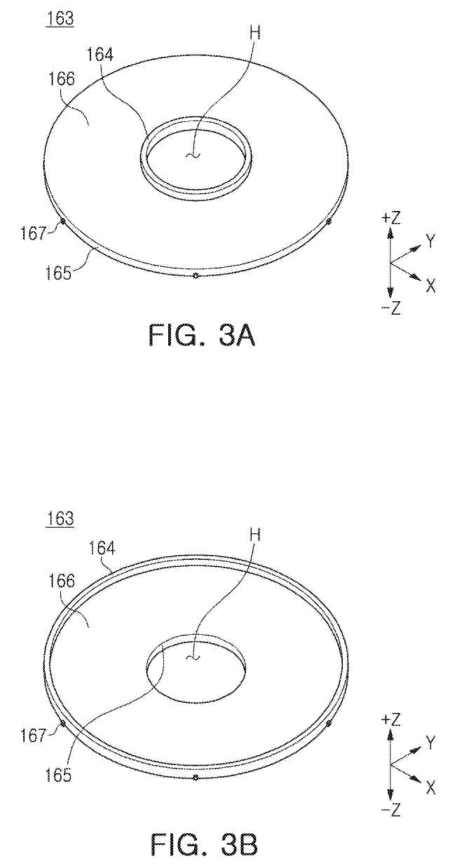

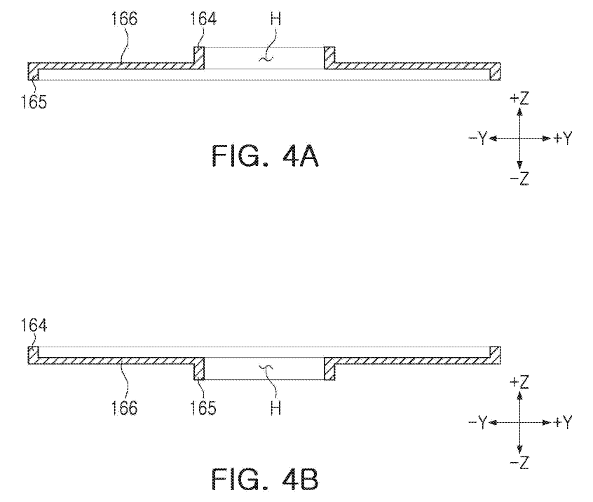

A detailed shape of the insulating plate 163 will be described later with reference to FIGS. 3A and 3B and FIGS. 4A and 4B.

FIGS. 3A and 3B are perspective views of insulating plates 163 according to various embodiments. FIGS. 4A and 4B are cross-sectional views of the insulating plates 163 of FIGS. 3A and 3B.

The insulating plate 163 of FIGS. 1 and 2 may also be applied to insulating plates 163 of FIGS. 3A and 3B and FIGS. 4A and 4B.

Referring to FIGS. 3A and 3B and FIGS. 4A and 4B, according to an embodiment, an insulating plate 163 may include a first portion 164 contacting an upper plate 112, a second portion 165 contacting an electrode assembly 120 or a first current collector 131, and a third portion 166 formed between the first portion 164 and the second portion 165. In this case, any one of the first portion 164 or the second portion 165 may be disposed to be adjacent to an edge of a hollow portion H, and the other thereof may be disposed to be adjacent to an edge of the insulating plate 163.

The first portion 164 may refer to a portion of the insulating plate 163 that may be in contact with the upper plate 112, and may be disposed to be adjacent to the edge of the hollow portion H or disposed to be adjacent to the edge of the insulating plate 163. The first portion 164 is illustrated in a shape protruding in a direction (+Z direction) toward the upper plate 112, but is not limited to this shape, and when a portion is formed to be adjacent to the edge of the hollow portion H or the edge of the insulating plate 163 so as to contact the upper plate 112, the portion may be included in the first portion 164 of the present disclosure.

The second portion 165 may refer to a portion of the insulating plate 163 that may be in contact with the electrode assembly 120 or the first current collector 131, and may be disposed to be adjacent to the edge of the hollow portion H or disposed to be adjacent to the edge of the insulating plate 163. Likewise, the second portion 165 is illustrated in a shape protruding in a direction (-Z direction) toward the electrode assembly 120, but is not limited to this shape, and when a portion is formed to be adjacent to the edge of the hollow portion H or the edge of the insulating plate 163 so as to contact the electrode assembly 120 or the first current collector 131, the portion may be included in a second portion 165 of the present disclosure.

The insulating plate 163 may be disposed in a space between the upper plate 112 and the electrode assembly 120 such that a portion thereof may be in contact with the upper plate 112, and another portion thereof may be in contact with the electrode assembly 120 or the first current collector 131, thereby supporting the electrode assembly 120. Accordingly, the insulating plate 163 may provide uniformity in assembly of a cell case 110 and the electrode assembly 120. Specifically, as the insulating plate 163 supports the electrode assembly 120 in the vicinity of the edge of the hollow portion H or in the vicinity of the edge of the insulating plate 163, uniformity may be provided in the assembly by suppressing the electrode assembly 120 from moving in a height direction (Z-axis direction) in the cell case 110.

A portion of the insulating plate 163 formed between the first portion 164 and the second portion 165 may be referred to as the third portion 166.

Referring to FIG. 3A and FIG. 4A, according to an embodiment, the first portion 164 may be disposed to be adjacent to the edge of the hollow portion H, and the second portion 165 may be disposed to be adjacent to the edge of the insulating plate 163. Accordingly, the insulating plate 163 may support the electrode assembly 120 in a peripheral portion of the electrode assembly 120.

Referring to FIG. 3B and FIG. 4B, according to an embodiment, the first portion 164 may be disposed to be adjacent to the edge of the insulating plate 163, and the second portion 165 may be disposed to be adjacent to the edge of the hollow portion H. Accordingly, the insulating plate 163 may support the electrode assembly 120 in a central portion of the electrode assembly 120.

According to an embodiment, the insulating plate 163 may further include a bump 167 protruding radially outward from an outer circumferential surface of the insulating plate 163. The bump 167 may be provided in plural. In this case, the bump 167 may be disposed to be in contact with an inner surface of a sidewall 111. When the insulating plate 163 attempts to rotate as the bump 167 contacts the inner surface of the sidewall 111, the rotation of the insulating plate 163 may be suppressed through a frictional force. In this case, the inner surface of the sidewall 111 may refer to an inner circumferential surface of the cell case 110.

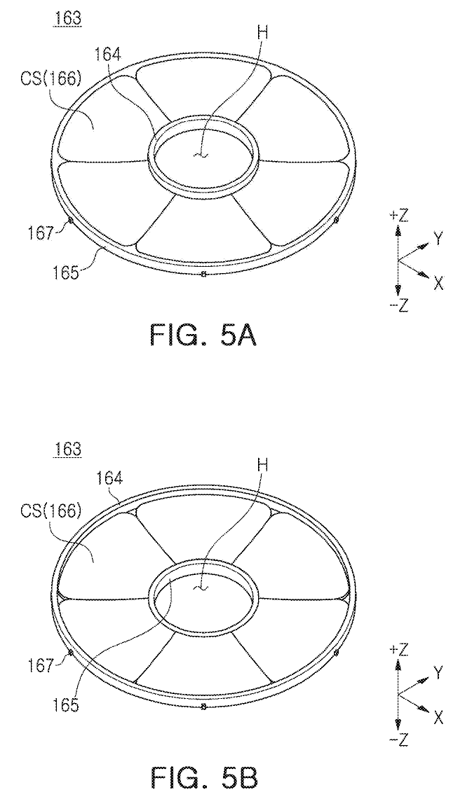

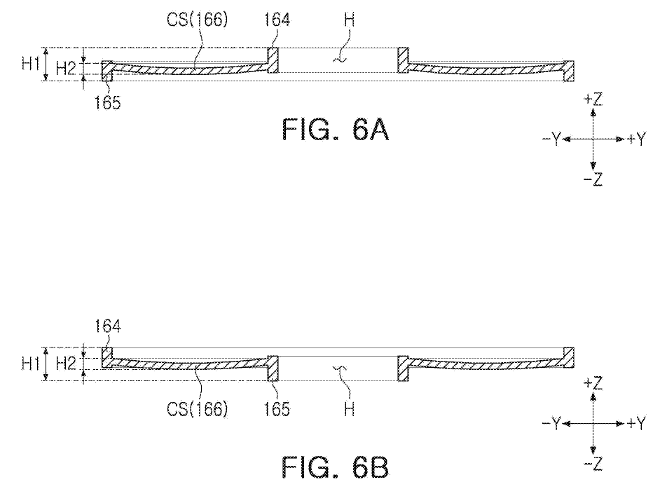

FIGS. 5A and 5B are perspective views of insulating plates 163 according to various embodiments. FIGS. 6A and 6B are cross-sectional views of the insulating plates 163 of FIGS. 5A and 5B.

Contents of the insulating plate 163 of FIGS. 1 to FIGS. 4A and 4B may also be applied to insulating plates 163 of FIGS. 5A and 5B and FIGS. 6A and 6B.

Differences between the insulating plates 163 of FIGS. 5A and 5B and FIGS. 6A and 6B will be mainly described.

An insulating plate 163 may be configured to provide a spring-back force. Alternatively, the insulating plate 163 may be configured to provide an elastic force to an electrode assembly 120.

According to an embodiment, a third portion 166 may include at least one curved portion CS. The curved portion CS may provide an elastic force to the electrode assembly 120 through a bending resistance. Therefore, when an external impact is applied to a battery cell 100, the third portion 166 including the curved portion CS may absorb the impact applied to the electrode assembly 120. Accordingly, stability may be provided to the battery cell 100.

According to an embodiment, the at least one curved portion CS may include a plurality of curved portions CS. As the plurality of curved portions CS are provided, the third portion 166 may provide a greater elastic force to the insulating plate 163. For example, an external impact or vibration applied to the battery cell 100 may be better absorbed. The curved portion CS may be provided in a shape bent in a direction toward the electrode assembly 120 or bent in a direction toward an upper plate 112. Alternatively, the curved portion CS may be provided in a concave shape or a convex shape.

Also, curvature of the curved portion CS may be appropriately selected depending on a design. For example, a height H2 of the curved portion CS may be less than or equal to a height H1 of the insulating plate 163. The height H1 of the insulating plate 163 may refer to a length of the insulating plate 163 in the Z-axis direction. The height H2 of the curved portion CS may refer to a length of the Z-axis direction from a portion in which a curved surface starts to the most concave portion or the most convex portion.

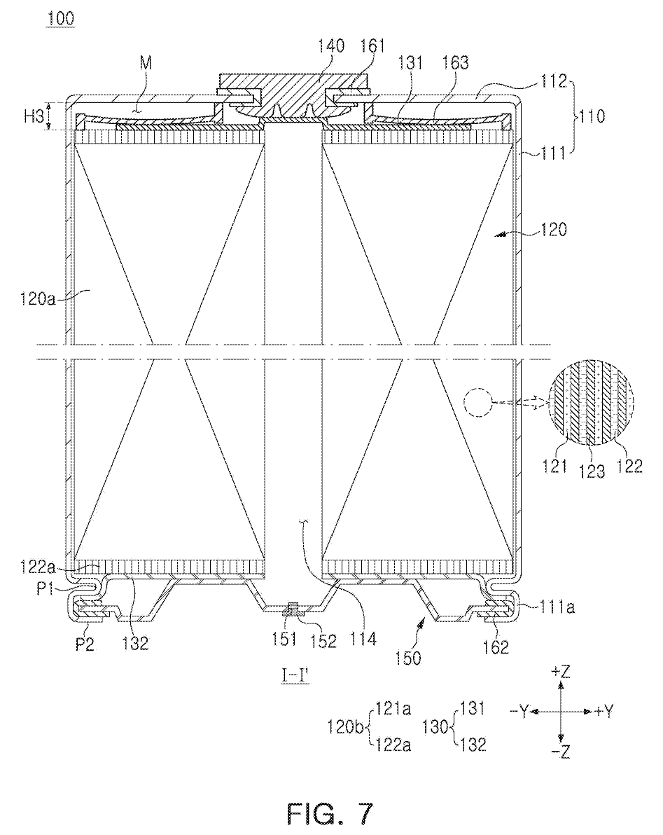

FIG. 7 is a cross-sectional view of a battery cell 100 according to an embodiment.

Contents of the cell case 110, the electrode assembly 120, the electrode terminal 140, the first current collector 131, and the insulating plate 163 of FIGS. 1 and 2 may also be applied to a cell case 110, an electrode assembly 120, an electrode terminal 140, a first current collector 131, and an insulating plate 163 of FIG. 7.

A surplus space M may be formed between an upper plate 112 and the electrode assembly 120. When an external impact or vibration is applied due to the surplus space, the electrode assembly 120 may move in a height direction (Z-axis direction) within the cell case 110.

The insulating plate 163 may be disposed in the surplus space. A height (height H1 of FIG. 6) of the insulating plate 163 may be equal to a height H3 of the surplus space. Accordingly, the insulating plate 163 may suppress movement of the electrode assembly 120 in the cell case 110 by providing an elastic force.

According to an embodiment, a battery cell 100 may further include a cap plate 150 covering a lower side of an accommodation space 114 of the cell case 110. The cap plate 150 may be coupled to the cell case 110. The cap plate 150 may cover the accommodation space 114 on a side opposite to the electrode terminal 140.

The cap plate 150 may be coupled to the cell case 110 by a crimping method. As an example, a beading portion P1 may be formed by beading an open end portion 111a of a sidewall 111 of the cell case 110, and then the end portion 111a of the sidewall 111 and the cap plate 150 may be crimped while the cap plate 150 is disposed on the beading portion P1 to form a crimping portion P2.

The cap plate 150 may include an injection port 151 for injecting an electrolyte into the cell case 110, and a sealing member 152 for sealing the injection port 151. The injection port 151 may be formed in a central portion of the cap plate 150, but a position or size thereof may be variously changed. The injection port 151 may be sealed with the sealing member 152 after injecting the electrolyte. The sealing member 152 may be provided in a ball type or a cap type.

A cap gasket 162 for sealing may be disposed between the cap plate 150 and the sidewall 111 of the cell case 110. The cap gasket 162 may serve as a sealing member for sealing a space between the cap plate 150 and the sidewall 111.

According to an embodiment, the battery cell 100 may further include a second current collector 132 electrically connected to a second electrode tab 122a of the electrode assembly 120.

An upper surface of the second current collector 132 may be configured to be bonded to or contact the second electrode tab 122a, to be electrically connected to the second electrode tab 122a. Welding may be used for bonding the second current collector 132 and the second electrode tab 122a. For example, the second current collector 132 and the second electrode tab 122a may be bonded to each other by ultrasonic welding, laser welding, resistance welding, or the like. Alternatively, the second current collector 132 may not be bonded to the second electrode tab 122a, but may be electrically connected to each other in a state contacting each other.

The second current collector 132 may not be disposed, and the second electrode tab 122a may be directly electrically connected to the cap plate 150.

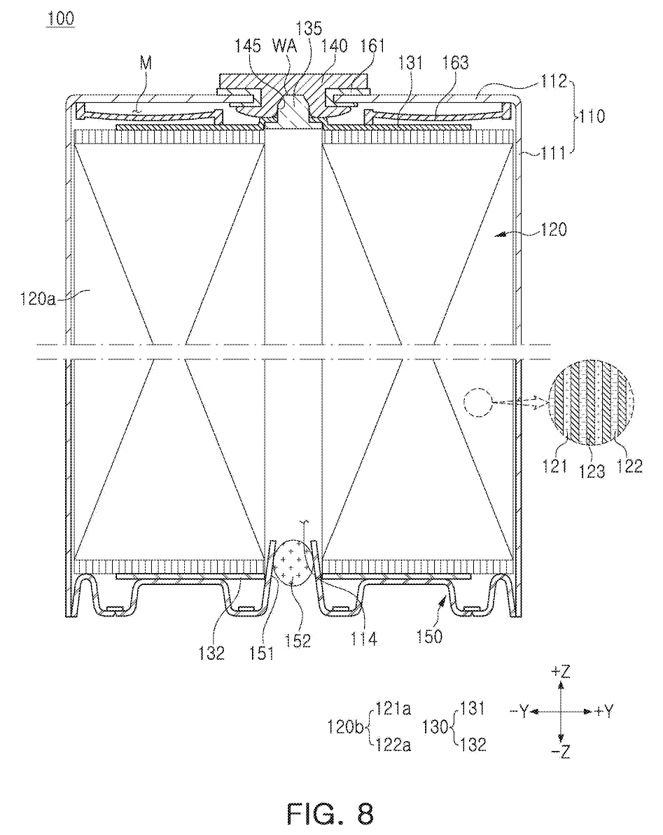

FIG. 8 is a cross-sectional view of a battery cell 100 according to another embodiment.

According to an embodiment, a first current collector 131 may further include a protrusion 135 protruding in a direction toward an electrode terminal 140, and the electrode terminal 140 may further include an insertion groove 145 into which the protrusion 135 is inserted. The protrusion 135 may reduce costs in a process of electrically connecting the first current collector 131 and the electrode terminal 140.

The protrusion 135 may be inserted into and coupled to the insertion groove of the electrode terminal 140. The protrusion 135 of the first current collector 131 and the insertion groove 145 of the electrode terminal 140 may have shapes corresponding to each other. The electrode terminal 140 and the protrusion 135 of the first current collector 131 may be bonded to each other and electrically connected to each other through laser welding. A direction in which laser is irradiated during laser welding may be a direction perpendicular to an upper plate 112. In the laser irradiation direction, a portion in which the electrode terminal 140 and the protrusion 135 are in contact with each other may form a welded portion WA.

According to an embodiment, the protrusion 135 may be inserted into the insertion groove 145 formed in a lower portion of the electrode terminal 140, and the electrode terminal 140 may be electrically connected to the protrusion 135 of the first current collector 131 through welding in an external space of a cell case 110. This may prevent occurrence of welding foreign substances (e.g., foreign substances such as fumes or spatters) inside a battery cell 100. In addition, since metal foreign substances such as fumes or spatters do not occur inside the cell case 110, a dust collection operation inside the case may not be required during a welding operation, and accordingly, costs for installing facilities for dust collection may be reduced.

According to an embodiment, a cap plate 150 may be welded to the cell case 110. As an example, the cap plate 150 may be welded to an end portion 111a of a sidewall 111.

According to an embodiment, an injection port 151 of the cap plate 150 may be sealed by a sealing member 152. In this case, the sealing member 152 may be provided in a ball form.

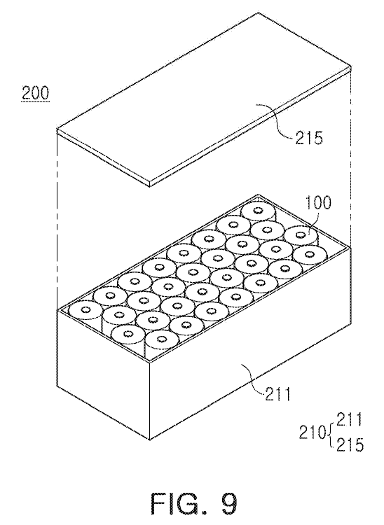

FIG. 9 is a perspective view of a battery module 200 according to an embodiment.

Contents of the battery cells 100 of FIGS. 1 to 8 may be applied in the same manner to a battery cell 100 provided in a battery module 200 of FIG. 9.

Referring to FIG. 9, a battery module 200 in the present disclosure may include a plurality of battery cells 100 and a module housing 210 accommodating the plurality of battery cells 100.

When a battery module 200 of the present disclosure includes a plurality of battery cells 100, a specific type thereof is not limited. For example, the battery module 200 of the present disclosure may be defined to include all of a battery pack, an energy storage device, or the like.

A module housing 210 may provide a space for accommodating the plurality of battery cells 100. The module housing 210 may include a housing body 211 forming a space for accommodating the plurality of battery cells 100, and a housing cover 215 covering an upper side of the plurality of battery cells 100.

According to an embodiment, an insulating plate providing uniform assemblability when manufacturing a battery cell may be provided.

According to an embodiment, an insulating plate for improving stability of a battery cell by buffering an external impact may be provided.

Only specific examples of implementations of certain embodiments may be described. Variations, improvements and enhancements of the disclosed embodiments and other embodiments may be made based on the disclosure of this patent document.

What is claimed is:

1. A battery cell comprising:
a cell case including a sidewall forming an accommodation space therein, and an upper plate in which a through-hole is formed;
an electrode assembly disposed in the accommodation space of the cell case;
an insulating plate disposed between the electrode assembly and the upper plate and including a hollow portion;
a first current collector electrically connected to a first electrode tab of the electrode assembly; and
an electrode terminal electrically connected to the first current collector through the through-hole,
wherein the insulating plate includes:
a first portion contacting the upper plate;
a second portion contacting the electrode assembly or the first current collector; and
a third portion formed between the first portion and the second portion, and
wherein one of the first portion or the second portion is disposed to be adjacent to an edge of the hollow portion, and the other thereof is disposed to be adjacent to an edge of the insulating plate.

2. The battery cell of claim 1, further including a bump protruding outwardly from an outer peripheral surface of the insulating plate.

3. The battery cell of claim 2, wherein the bump is disposed to contact an inner surface of the sidewall.

4. The battery cell of claim 1, wherein the third portion includes at least one curved portion.

5. The battery cell of claim 4, wherein the at least one curved portion includes a plurality of curved portions.

6. The battery cell of claim 4, wherein a height of the curved portion is less than or equal to a height of the insulating plate.

7. The battery cell of claim 1, wherein the first portion is disposed to be adjacent to the edge of the hollow portion, and
the second portion is disposed to be adjacent to the edge of the insulating plate.

8. The battery cell of claim 1, wherein the first portion is disposed to be adjacent to the edge of the insulating plate, and
the second portion is disposed to be adjacent to the edge of the hollow portion.

9. The battery cell of claim 1, wherein the first current collector further includes a protrusion protruding toward the electrode terminal, and
the electrode terminal further includes an insertion groove into which the protrusion is inserted.

10. The battery cell of claim 1, further including a cap plate covering a lower side of the accommodation space of the cell case,
wherein the cap plate is coupled to the cell case.

11. The battery cell of claim 1, wherein the upper plate and the sidewall are integrally formed.

12. A battery module comprising:
a plurality of battery cells; and
a module housing accommodating the plurality of battery cells,
wherein at least one of the plurality of battery cells includes:
a cell case including a sidewall forming an accommodation space therein, and an upper plate in which a through-hole is formed;
an electrode assembly disposed in the accommodation space of the cell case;
an insulating plate disposed between the electrode assembly and the upper plate and including a hollow portion;
a first current collector electrically connected to a first electrode tab of the electrode assembly; and
an electrode terminal electrically connected to the first current collector through the through-hole,
wherein the insulating plate includes:
a first portion contacting the upper plate;
a second portion contacting the electrode assembly or the first current collector; and
a third portion formed between the first portion and the second portion, and
wherein one of the first portion or the second portion is disposed to be adjacent to an edge of the hollow portion, and the other thereof is disposed to be adjacent to an edge of the insulating plate.

13. The battery module of claim 12, wherein the third portion includes at least one curved portion.
